(19) United States
(12) Patent Application Publication
(10) Pub. No.: US 2003/0006060 A1
(43) Pub. Date: Jan. 9, 2003

(54) Mount for touch memory button carriers

(75) Inventors: Barry Markwitz, Cleveland, OH (US); Dean Chriss, Cleveland, OH (US)

Correspondence Address: HAHN LOESER & PARKS, LLP, TWIN OAKS ESTATE, 1225 W. MARKET STREET, AKRON, OH, 44313, US

(73) Assignee: TimeKeeping Systems Incorporated

(21) Appl. No.: 09/898,225

(22) Filed: Jul. 3, 2001

(51) Int. Cl. H01B 17/00

(52) U.S. Cl. 174/149 R

(57) ABSTRACT

The touch button data carrier mount of the present invention is comprised of two flanges which meet to form a circular central hub portion. The circular central hub portion has a hole therein adapted to engage a touch button and hold the touch button adjacent to a surface. The flanges include a means for securing the mounting device to a surface, such means including but not limited to holes for screws, rivets, nails, bolts or any other known means. The device also includes protective walls around the sides of the central hub to protect the touch button mounted therein from damage, particularly from contact with battery terminals.

### TECHNICAL FIELD

The present invention relates to an improved mount for touch memory button carriers. More specifically, the invention relates to a mount for touch memory button carriers that also prevents vandalism to the touch button data carriers.

### BACKGROUND OF THE INVENTION

The present invention is directed to components of an improved guard tour system, which includes advanced electronic hardware and software with improved data acquisition and reporting capabilities. The guard tour system related to the present invention improves efficiency and insures that guard tours are completed accurately and that any security problems are detected quickly.

During a guard tour, a guard is typically required to visit a certain location a specified number of times during a watch. Guards are generally required to keep a log including the time and frequency of their visits to this specified location. The present invention is directed to systems where touch memory buttons are positioned at specified locations where a guard is supposed to visit on a tour. These touch memory buttons are compatible with a reader. The touch memory button reader can be touched to the memory button and the reader and/or button will store data about that particular visit, such as identifying information about the location, date, time, or special circumstances surrounding the visit to that location. At the end of the tour, the guard can download the information from the buttons/readers using a computer program.

The touch buttons are typically mounted to a wall or other surface using a mounting device. The touch memory buttons are configured such that a conductive terminal is formed around the circumference of the top of the touch memory buttons. It has been discovered, that by applying a voltage (e.g., a typical nine volt battery) across the diameter of the buttons to contact the lead terminals of the memory button, the data storing and reading capabilities can be destroyed. Based on the foregoing, it is an object of the present invention to provide a touch memory button mounting device which will substantially prevent the touch memory buttons functions from being destroyed by contact with a nine volt battery.

Therefore, in light of the foregoing deficiencies in the prior art, the applicant's invention is herein presented.

### SUMMARY OF THE INVENTION

The guard tour system of the present invention is comprised of a computer running a computer program that enables a variety of electronic hardware components to function as the guard tour system. It is also contemplated that the computer program be multi-user and/or network compatible. The electronic hardware includes one or more touch button readers; one or more downloaders for use with the touch button readers and a plurality of touch memory buttons located along a guard tour. Each touch memory button includes preprogrammed information specific to its particular location. As a guard or night watchman progresses through the guard tour he or she reads the information stored within each touch memory button using a hand-held, battery operated touch button reader. At the end of the tour the guard then places the touch button reader in a downloader which transfers the stored data to one or more central computers for processing.

The present invention is directed to a device for mounting a data storage button device, and more specifically a touch memory button to a wall or other surface. The touch memory buttons used with mounting devices in the prior art and in the present invention consist of a circular electronic device which has two conductive surfaces separated by an insulating member. It has been discovered that the diameter of these buttons is similar to the distance between the two conductive terminals of a standard nine volt battery. In some situations, applying the nine volt battery terminals across the buttons has caused the buttons to malfunction. Thus, the present invention was developed to prevent such damage from being inflicted on buttons which are mounted to surfaces. Thus, the present invention discloses a mounting device for a touch memory button which precludes contact between nine volt battery terminals and the lead terminals of the memory buttons.

Specifically, the present invention relates to a mounting device for a circular data storage button which has two conductive surfaces separated by an insulating member. The mounting device comprises a means for holding a data storage button against a surface, a means for securing the mounting device to a surface and a means for preventing terminals of a nine volt battery from contacting conductive surfaces across the data storage button. In a preferred embodiment, the invention is used in conjunction with a data storage button which has a ridge projecting outwardly around its circumference. In this embodiment, the mounting device comprises two flanges, where the flanges meet to define a circular central hub and the circular central hub has an opening of substantially the same diameter as the data storage button. This embodiment further has a groove around the circumference of said opening at the bottom surface of the mounting plate. The groove is included so that an upper surface of the ridge frictionally engages the groove when the data storage button is placed through the opening. To protect the button from damage, a pair of semi-circular protective walls are positioned on opposite sides of said circular central hub and a combination of a distance between said semi-circular protective walls and a height of said semi-circular protective walls is sufficient to prevent two terminals of a nine volt battery from contacting conductive surfaces across said data storage button. Finally, a preferred embodiment includes holes in the ends of the flanges opposite the circular central hub. The holes are used for securing the mounting device to a surface.

These along with other objects and advantages of the present invention will become more readily apparent from a reading of the detailed description taken in conjunction with the drawings and the claims.

### BRIEF DESCRIPTION OF THE DRAWINGS

FIG. 1 is a side view of a prior art touch memory button.

FIG. 2 is a top view of a prior art touch memory button mounting device.

FIG. 3 is a side cross sectional view of a prior art touch memory button mounting device.

FIG. 4 is a lengthwise view of a prior art touch memory button mounting device.

FIG. 5 is a top perspective view of a touch memory button mounting device in accordance with the present invention.

FIG. 6 is a bottom perspective view of a touch memory button mounting device in accordance with the present invention.

FIG. 7 is a top view of a touch memory button mounting device in accordance with the present invention.

FIG. 8 is a lengthwise view of a touch memory button mounting device in accordance with the present invention.

FIG. 9 is a side view of a touch memory button mounting device in accordance with the present invention.

FIG. 10 is a side cross sectional view of a prior art touch memory button mounting device including a touch memory button.

FIG. 11 is a side cross sectional view of a touch memory button mounting device including a touch memory button in accordance with the present invention.

### DETAILED DESCRIPTION OF THE PREFERRED EMBODIMENT

The present invention is fully described hereinafter with reference to the drawings, in which preferred embodiments of the invention are shown. The invention may also be embodied in many different forms and should not be construed as limited to only the disclosed embodiments. The provided embodiments are included so the disclosure will be thorough, complete and will fully convey the scope of the invention to persons of ordinary skill in the art.

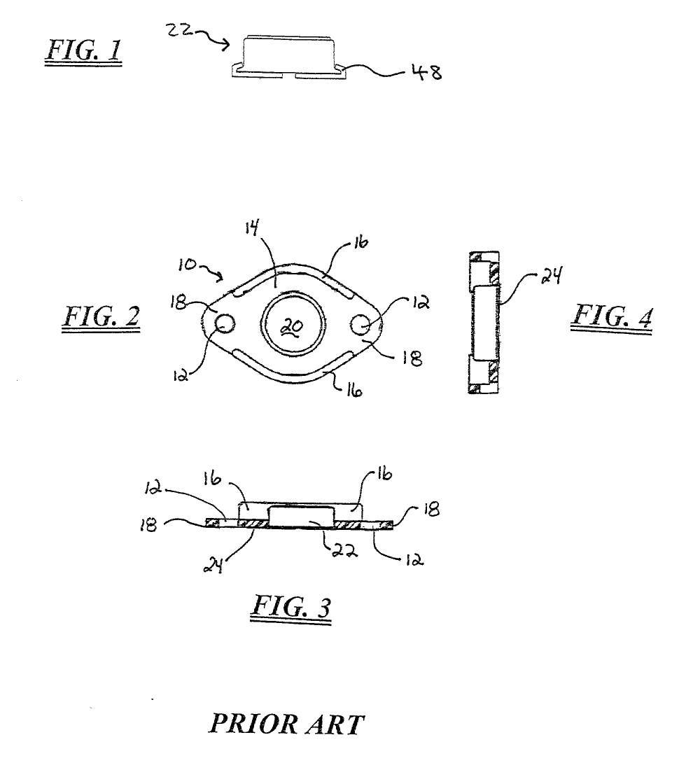

FIG. 1 illustrates a data storage or touch memory button 22, which is manufactured by Dallas Semiconductor. FIGS. 2-4 and 10 illustrate prior art data storage or touch memory button mounting devices, generally designated 10. The mounting devices allow for permanent or removable attachment of the data storage buttons to a wall or other object. The prior art mounting devices are comprised of a plastic plate made up of two flanges 18 which meet to form an elongated oval central portion 14. The prior art mounting device 10 has a hole 20 in the oval central hub 14 for positioning the button 22 (FIG. 3). An end of each flange 18 has a hole 12 therein for mounting the button to a wall or other object. The mounting devices may be secured to the object by use of screws, rivets, bolts or other known fastening means placed through holes 12. In the prior art, short slightly curved protective walls 16 are provided on the sides of the plate to protect the buttons 22 from incidental damage.

The bottom 24 of the plate is flat except for a groove around the circumference of the hole 20. This groove corresponds to a ridge 48 which projects from around the circumference at the bottom of a data storage button. Thus, when button 22 is inserted in the hole 20, the bottom of the button is flush with the bottom 24 of the mounting plate 10 (FIGS. 3-4). This allows the mounting device to be mounted flush against a flat object or surface.

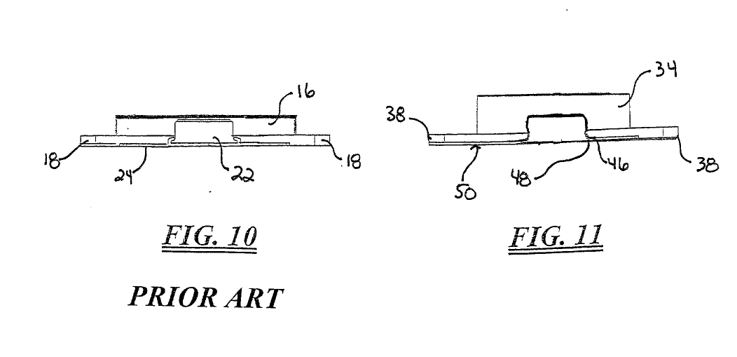

FIG. 10 illustrates a side view of the prior art mount showing a button positioned therein. In the prior art mounting devices, the height of the walls 16 and the height of the button are similar such that when the button is positioned in the mounting device, the top of the button is nearly level with the walls of the mounting device. Thus, in the prior art, the terminals of a nine volt battery could be placed across the memory button terminals.

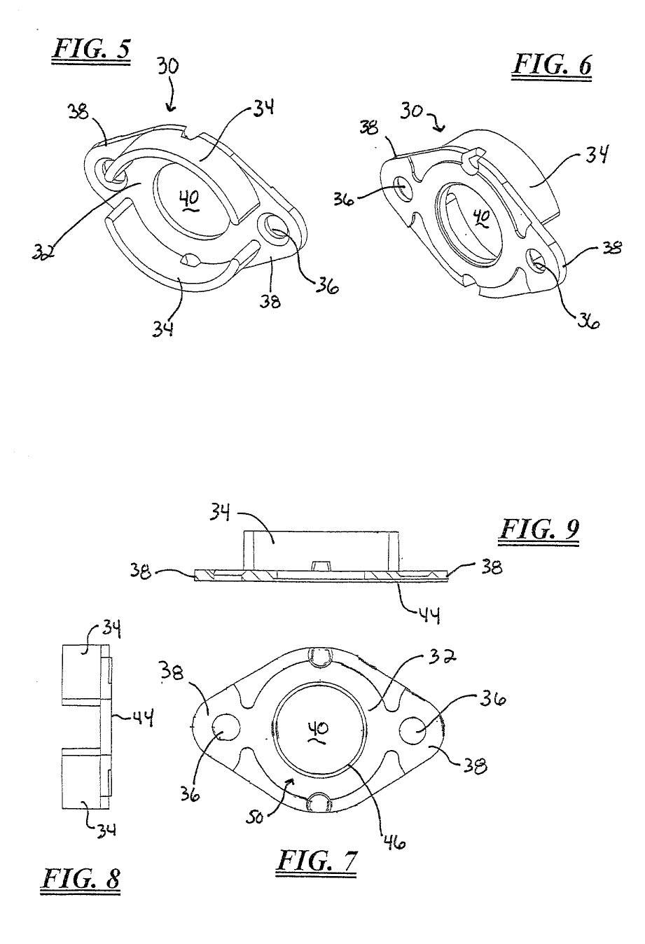

FIGS. 5-9 and 11 illustrate the mounting device of the present invention generally designated 30. The data storage button mounting device of the present invention comprises a plate having a two oppositely disposed flanges 38 which meet to form a substantially round or circular central hub 32. The flanges 38 narrow towards the other ends. The central hub 32 has an opening or hole 40 therein for positioning the button. As shown in FIG. 7 and 11, on the bottom surface of the plate, the opening is provided with a groove 46. The groove 46 in the mounting plate corresponds to a ridge 48 projecting outwardly around the circumference at the bottom of the button. Frictional engagement of the groove 46 on the bottom surface of the mounting plate and the upper surface of the ridge on the button holds the button in place when the mounting plate is secured to an object.

Each of the flanges 38 has a hole 36 therein at an end opposite the central hub for mounting the plate to a wall or other object. The plate may be mounted using screws, nails, rivets, bolt/nut combinations, adhesives or any other known fastening means.

Protective walls 34 are provided on opposite sides of the hub. The protective walls 34 in the present invention have a substantially half-circle shape forming a broken circle around the hub where the button would be positioned. In the alternative protective walls could form a full circle around the hub 32. The protective walls 34 form a cavity at the hub 32. The circular protective walls 34 are dimensioned such that the terminals of a standard nine volt battery would not be able to penetrate into the cavity formed by the protective walls and contact the button terminals. Thus, the height of the protective walls 34 and the diameter of the half circle or circle of the protective walls are such that the terminals of a standard nine volt battery would not be able to reach far enough into the mounting device to contact the button terminals. However, the protective walls are formed so as not to obstruct a touch button reader from being inserted into the mounting device.

The bottom 44 of the plate is substantially flat. When a button is inserted in the mounting the bottom of the button is substantially flush with the bottom of the plate. The groove 46 in the plate mechanically engages the upper surface of the ridge 48 around the bottom of the button to hold said button in place on the surface of a wall or other object. This will allow the mounting device plate to be mounted substantially flush with a flat surface or object.

The data storage button mounting devices of the present invention are preferably fabricated of a rigid plastic material but may also be made of metal, provided that the metal does not have properties which would interfere with operation of the button.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention as defined in the claims. Within the claims, means-plus-function language is intended to cover the structures described in the present application as performing the recited function, and not only structural equivalents but also equivalent structures. The written description and drawings illustrate the present invention and are not to be construed as limited to the specific embodiments disclosed. Modifications to the disclosed embodiments, as well as other embodiments, are included within the scope of the claims. The present invention is defined by the following claims, including equivalents thereof.

What is claimed is:

1. A mounting device for a circular data storage button wherein said data storage button comprises two conductive surfaces separated by an insulating member and a ridge projecting outwardly around its circumference, said ridge having an upper surface and a lower surface, said mounting device comprising:
a first flange and a second flange;
said first flange and said second flange meeting to define a circular central hub;
said circular central hub having an opening of substantially the same diameter as said data storage button;
a groove disposed around the circumference of said opening, such that an upper surface of said ridge frictionally engages said groove when said data storage button is placed through said opening, such that a bottom surface of said button is flush with a bottom surface of said mounting device;
a pair of semi-circular protective walls positioned on opposite sides of said circular central hub;
said first flange and said second flange having a hole in an end opposite said circular central hub for securing said mounting device to a surface; and
wherein a combination of a distance between said semi-circular protective walls and a height of said semi-circular protective walls is sufficient to prevent two terminals of a nine volt battery from contacting conductive surfaces across said data storage button.

2. The mounting device as recited in claim 1 wherein said mounting device is secured to a surface by a member of the group consisting of screws, nails, rivets, bolts and adhesives.

3. A mounting device for a circular data storage button having two conductive surfaces separated by an insulating member, said mounting device comprising:
means for holding a data storage button against a surface;
means for securing said mounting device to a surface;
means for preventing terminals of a nine volt battery from contacting conductive surfaces across said data storage button.

4. The mounting device as recited in claim 3, wherein said circular data storage button comprises a ridge projecting outwardly around its circumference and wherein said means for holding said data storage button against a surface comprises:
a first flange and a second flange;
said first flange and said second flange meeting to define a circular central hub;
said circular central hub having an opening of substantially the same diameter as said data storage button; and
a groove disposed around the circumference of said opening, such that an upper surface of said ridge engages said groove when said data storage button is place through said opening.

5. The mounting device as recited in claim 4, wherein a bottom surface of said data storage button is flush with a bottom surface of said mounting device.

6. The mounting device as recited in claim 3 wherein said means for securing said mounting device to a surface comprises:
a first flange and a second flange;
said first flange and said second flange meeting to define a circular central hub capable of receivably holding said data storage button;
said first flange and said second flange having a hole in an end opposite said circular central hub for securing said mounting device to a surface.

7. The mounting device as recited in claim 6 wherein said mounting device is secured to a surface by a member of the group consisting of screws, nails, rivets, bolts and adhesives.

8. The mounting device as recited in claim 3 wherein said means for preventing terminals of a nine volt battery from contacting conductive surfaces of a data storage button comprises:
a first flange and a second flange;
said first flange and said second flange meeting to define a circular central hub capable of receivably holding said data storage button;
a pair of semi-circular protective walls positioned on opposite sides of said circular central hub; and
wherein a combination of a distance between said semi-circular protective walls and a height of said semi-circular protective walls is sufficient to prevent two terminals of a nine volt battery from contacting conductive surfaces across said data storage button.

9. An apparatus for mounting data storage buttons comprising:
a circular data storage button comprising a two conductive surfaces separated by an insulating member and an outwardly extending ridge around the circumference of said circular data storage button;
a plate mounting apparatus comprising,
a first flange and a second flange;
said first flange and said second flange meeting to define a circular central hub capable of receivably holding said circular data storage button;
a pair of semi-circular protective walls positioned on opposite sides of said circular central hub;
said first flange and said second flange having a hole in an end opposite said circular central hub for securing said mounting device to a surface; and
wherein a combination of a distance between said semi-circular protective walls and a height of said semi-circular protective walls is sufficient to prevent two terminals of a nine volt battery from contacting conductive surfaces across said data storage button.

10. The apparatus as recited in claim 9 wherein said circular central hub comprises an opening of substantially the same diameter as said data storage button.

11. The apparatus as recited in claim 10 further comprising:
a groove disposed around the circumference of said opening, such that an upper surface of said ridge frictionally engages said groove when said data storage button is placed through said opening.

12. The apparatus as recited in claim 11 wherein a bottom surface of said data storage button is flush with a bottom surface of said central hub.
